(19) United States
(12) Patent Application Publication
(10) Pub. No.: US 2003/0194090 A1
(43) Pub. Date: Oct. 16, 2003

(54) Access point for authenticating apparatus, communicating apparatus subjected to authentication of access point, and system having them

(76) Inventor: Hirohide Tachikawa, Kanagawa (JP)

Correspondence Address: MORGAN & FINNEGAN, L.L.P., 345 PARK AVENUE, NEW YORK, NY, 10154, US

(21) Appl. No.: 10/411,590

(22) Filed: Apr. 10, 2003

(30) Foreign Application Priority Data
Apr. 12, 2002 (JP) 2002-110491

(51) Int. Cl. H04L 9/00

(52) U.S. Cl. 380/270; 713/172

(57) ABSTRACT

Account data by which an access point authenticates a communicating apparatus is stored in a detachable memory device. After the account data stored in the detachable memory device was updated on the communicating apparatus side, when the detachable memory device is attached to the access point, the access point discriminates whether the account data has been updated or not. If it has been updated, the account data stored in a memory of the access point is rewritten to the updated account data. After that, the authentication of the communicating apparatus is made by using the updated account data.

### BACKGROUND OF THE INVENTION

1. Field of the Invention

The invention relates to an access point, a communicating apparatus, a system, and their control method, which are suitable in the case where the communicating apparatus having a communicating function such as wireless LAN (IEEE 802.11), Bluetooth, or the like is authenticated and establishment of a network which takes into consideration security is realized.

2. Related Background Art

Hitherto, in a wireless LAN and Bluetooth, there is a problem such that since radio waves are used as a communication medium, it is difficult to restrict a communication destination. Therefore, in those standards, security means such that by changing an encryption key every communication destination, even if someone peeps a packet, it cannot be decrypted is used. Among the security means, authenticating and encrypting means called IEEE802.1x (EAP) is becoming a defacto standard of wireless communication authenticating and encrypting means, and one of the reasons for it is Microsoft Corporation has used it for a Windows (registered trademark) platform.

According to the IEEE802.1x system in the wireless LAN (IEEE802.11), when a terminal of a client makes a network connecting request, it makes data communication with an authentication server (RADIUS server or the like) provided on the Intranet by using a TCP/IP (Transmission Control Protocol/Internet Protocol), and the authentication server makes a challenge to the client. The client inputs an account (information to identify the user) name and a password in response to the challenge. If a set of them coincides with data in the authentication server, the authentication server returns the encryption key of 128 bits to an access point and the client. When the client passes the authentication in such a process, subsequent wireless communication is encrypted by a method whereby the obtained encryption key of 128 bits is used as a WEP (Wired Equivalent Privacy) key and both of the client and the access point use it.

In Bluetooth, use of the IEEE802.1x authenticating and encrypting means is recommended in order to improve the security of a PAN profile. In the case of Bluetooth, the key for encrypting the radio waves as a wireless medium is automatically formed by mutual authentication by devices, which make communication by the Bluetooth system. Therefore, the encryption key information received from the authentication server cannot be used as an encryption key of the radio waves themselves like a WEP key used in the wireless LAN. However, by using the packet as a key upon encryption at a front stage of forming the radio waves as a wireless medium, the packet is double-encrypted and the security of communication can be improved.

In the authenticating and encrypting process of the IEEE802.1x system, the authentication server for making the authentication exists in the network and the accounts of the clients are concentratedly managed by the authentication server. Therefore, by using the IEEE802.1x system, wherever the client is, if communication with the authentication server by TCP/IP can be realized, the terminal of the client can be connected to the network such as an Intranet or the like by using the same account password.

However, there are the following problems in the above conventional technique. By using the authenticating and encrypting process according to the IEEE802.1x system as mentioned above, the client can realize safe network connection using the wireless communication. For this purpose, however, it is necessary that the authentication server has been installed in the network and the account of the client has previously been registered in the authentication server. That is, the IEEE802.1x system is a system, which is supposed to be used on the Intranet or the like of a relatively large scale. There is also a limitation such that the client who makes network connection in a wireless manner is limited to a member having the account in the authentication server.

There is, consequently, inconvenience such that in the case of having a meeting in which visitors without the accounts in the authentication server participate or in the case of having a meeting for a conference room out of an office where means for connecting to the Intranet does not exist, a safe network according to the wireless communication using the authenticating and encrypting process by the IEEE802.1x system cannot be established. At this time, although wireless communication in which the authentication and encryption are eliminated can be realized, it has a large problem in view of the security. Although the wireless communication can be encrypted if manual resetting of parameters for the wireless communication is performed, the client has to manually execute the connecting operation, which is completely different from the automatic connection according to the input of the account password of the IEEE802.1x system, which is generally used on the Intranet. The operation is complicated and convenience is lost.

### SUMMARY OF THE INVENTION

It is an object of the invention to enable a safe network to be easily and flexibly established.

Another object of the invention is to enable data for authentication to be flexibly updated.

Still another object of the invention is that even if account data for authentication is updated in an apparatus other than an access point, the updated account data can be easily reflected to the account data for authentication, which is managed by the access point.

The above and other objects and features of the present invention will become apparent from the following detailed description and the appended claims with reference to the accompanying drawings.

### BRIEF DESCRIPTION OF THE DRAWINGS

FIG. 1 a conceptual diagram showing a construction of a network system according to the first embodiment of the invention;

FIG. 2 is a block diagram showing an internal structure of an access point according to the first embodiment;

FIG. 3 is a flowchart showing processing contents of an account creating program according to the first embodiment;

FIG. 4 is a flowchart showing an account database updating procedure of the access point according to the first embodiment;

FIG. 5 is a block diagram showing a functional construction of the access point according to the first embodiment;

FIG. 6 is a block diagram showing relations among an extension wireless communication connector provided in the access point according to the first embodiment and IEEE802.11 and Bluetooth extension wireless board;

FIG. 7 is a block diagram showing a construction of a router & bridge of the access point according to the first embodiment;

FIG. 8 is a diagram showing a software layer structure of the access point according to the first embodiment;

FIG. 9 is an external view showing a construction of a client device according to the second embodiment of the invention;

FIG. 10 is a flowchart showing an account data obtaining process of the client device according to the second embodiment; and

FIG. 11 is a diagram showing a recording form of account data and an ESS ID in an account database according to the second embodiment.

### DESCRIPTION OF THE PREFERRED EMBODIMENTS

Prior to explaining details of embodiments of the invention, first, objects to be realized in the embodiments of the invention will be mentioned. In the embodiments of the invention, when a PAN (Personal Area Network) according to a client device in which the IEEE802.1x authenticating and encrypting system such as a Windows (registered trademark) platform or the like has been installed is established by wireless communication, the safe and flexible PAN can be easily established. When the PAN is established, wireless communicating means to be used is enabled to be easily selected. A plurality of wireless communicating means which are used upon establishment of the PAN are enabled to be simultaneously used and a PAN constructed by the different wireless communicating means to be easily established. The number of clients that can participate in the PAN is increased.

In the case where the PAN established by the wireless communicating means is connected to a basic network such as Intranet, Internet, or the like, illegal accesses are mutually inhibited. Costs, which are required in the case of making a product of the present access point are reduced. Upon establishment of the PAN, flexible participation such as temporary participation of the clients, participation by agents, or the like is permitted. The clients who participate in the PAN are concentratedly connected to the access point and client management can be integratedly executed by the present access point. The clients who participate in the PAN are selectively connected to a wireless communication extension card in the access point and management such as client distribution or the like can be realized by the present access point. Management regarding detachable non-volatile memory devices for account management is made easy.

Account data at the time of constructing the PAN by using the access point can be locally and flexibly created. Management of the clients and PAN establishment time can be flexibly made. When a plurality of PANs are established by using a plurality of access points or inserting a plurality of wireless communication extension cards into the access point, the client of each PAN is automatically connected to the access point corresponding to each PAN. If a plurality of accounts for PAN establishment is provided for the access point, the account for the PAN to be established is automatically discriminated and the PAN is established.

Characteristic construction and operation of the embodiment of the invention will now be mentioned. According to the embodiment of the invention, when the PAN by the client devices in which the IEEE802.1x authenticating and encrypting system such as a Windows (registered trademark) platform or the like has been installed is established by the wireless communication by fetching an authentication server necessary for IEEE802.1x authentication into the access point and supplying the account data for the authentication server from the detachable nonvolatile memory device, the safe and flexible PAN can be easily established. The wireless communicating means which is used upon establishment of the PAN can be easily selected by providing the wireless communicating function in the access point by the extension card and enabling the extension card to be easily changed.

By providing a plurality of card interfaces for extending the wireless communicating function into the access point and attaching cards of different communicating means to the interfaces, a plurality of wireless communicating means which are used upon establishment of the PAN can be simultaneously used and the PAN constructed by the different wireless communicating means can be easily established. By attaching a plurality of wireless communication cards such as IEEE802.11b or the like to those interfaces, the PAN by the clients of the number exceeding the number of users with which one card can cope can be established and load distribution of the clients can be realized. By performing routing or filtering of every user to the wireless communication clients which are connected to a basic network via the access point, the illegal accesses are mutually inhibited. A routing function and a server emulating function for authentication which the access point have are realized by a control unit such as a single CPU or the like and peripheral circuits, thereby reducing the costs which are required in the case of making a product.

The client obtains his own account data from the data in a detachable non-volatile memory device or previously downloads it into a non-volatile memory in the client device via the network and obtains it, and can use the obtained account upon participation in the PAN. Thus, flexible participation such as temporary participation of the clients, participation by agents, or the like is permitted upon establishment of the PAN.

The access point and the client device group obtain ESS ID (Extended Service Set ID) information which is used upon establishment of the PAN according to the wireless LAN together with the account data from the data of the detachable non-volatile memory device, or previously download it into the nonvolatile memory in the client device via the network and obtain it. The ESS ID can be changed every PAN constructed by the access point and the client device group. Thus, a group of clients who participate in the PAN is concentratedly connected to a certain access point and the client management is integratedly executed by the access point.

The access point and the client device group which have therein a plurality of wireless communication extension cards obtain a plurality of ESS ID information which is used upon establishment of the PAN according to the wireless LAN together with the account data from the data of the detachable non-volatile memory device, or previously download them into the non-volatile memory in the client device via the network and obtain them. The ESS ID can be changed every PAN constructed by the client device group corresponding to each wireless communication extension card in the access point. Thus, a group of clients who participate in the PAN is selectively connected to the wireless communication extension card in the access point and the management such as client distribution or the like is realized by the access point.

The detachable non-volatile memory device which is used for management of the account data is used in common by the access point and the client device, so that the PAN according to the invention is operated merely by managing the detachable non-volatile memory device for management of one set of accounts. An account creating program which operates in the personal computers or PDAs (Personal Digital Assistants) which are used mainly as client devices and registers the data in the detachable non-volatile memory device and the account data in the nonvolatile memory devices in the access point and the client device is prepared. Thus, the creation of the account data upon establishment of the PAN according to the invention can be locally and flexibly executed. The management of the clients and the PAN establishment time is flexibly executed.

An account creating program which operates in the personal computers or PDA which are used mainly as client devices and registers the data in the detachable non-volatile memory device and the account data and the ESS ID in the non-volatile memory devices in the access point and the client device is prepared. Thus, when a plurality of access points are used or when a plurality of wireless communication extension cards are built in the access point and a plurality of PANs according to the invention are established, the clients of each PAN are automatically connected to the corresponding access point or wireless communication extension cards.

Real-timer clock information built in the access point is compared with PAN establishment time information, which is stored in the detachable nonvolatile memory device or the non-volatile memory in the access point and supplied. Wireless communication parameters of the access point are automatically set on the basis of the account data in which the time information coincides, and the network connection is made on the basis of the parameters. Thus, when a plurality of accounts for PAN establishment is supplied to the access point, the accounts for PAN to be established are automatically discriminated and the PAN is established.

The authentication server necessary for IEEE802.1x authentication is fetched into the access point and the account data for the authentication server is accumulated once into the non-volatile memory in the access point via the network. After that, the account data for the authentication server is supplied from the non-volatile memory. Thus, when the PAN by the client devices in which the IEEE802.1x authenticating and encrypting system such as a Windows (registered trademark) platform or the like has been installed is established by the wireless communication, the safe and flexible PAN can be easily established.

The first to third embodiments of the invention will be described in detail hereinbelow with reference to the drawings.

First Embodiment

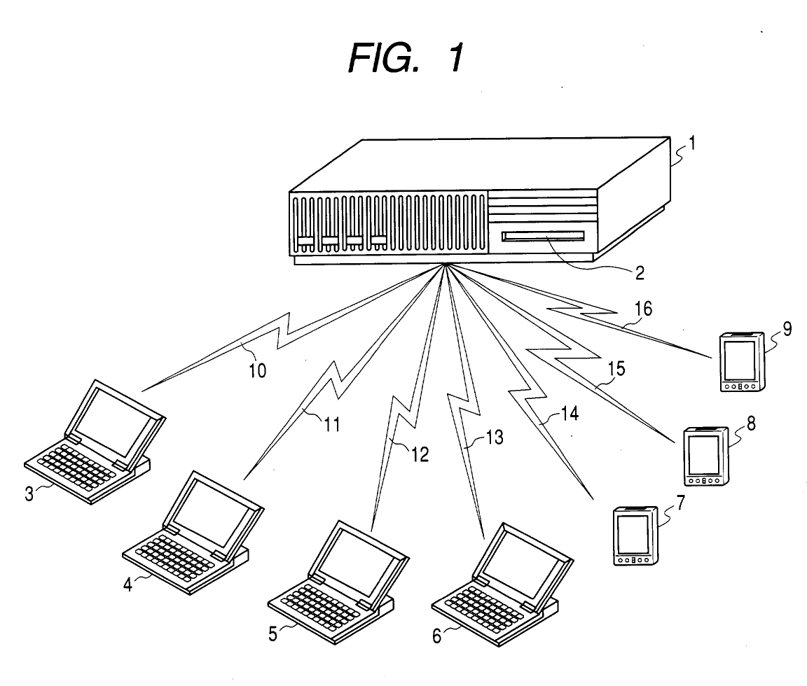

FIG. 1 is a conceptual diagram showing a construction of a network system according to the first embodiment of the invention. The network system comprises: an access point 1 having an IC card slot 2; personal computers (PCs) 3, 4, 5, and 6 serving as clients; Personal Digital Assistants (PDAs) 7, 8, and 9; and wireless communicating means 10, 11, 12, 13, 14, 15, and 16.

The access point 1 constructs a safe network by the wireless communicating means such as wireless LAN, Bluetooth, or the like, which is specified by IEEE802.11a.b.g.h or the like and is a connecting point with the user. A detachable non-volatile memory is inserted into the IC card slot 2. For an authentication server function built in the access point 1, account data including an account name and a password is supplied from the detachable non-volatile memory. The client personal computers 3, 4, 5, and 6 are connected to the PAN by the access point 1. The PDAs 7, 8, and 9 are connected to the PAN by the access point 1. The wireless communicating means 10, 11, 12, 13, 14, 15, and 16 have the wireless communicating function such as IEEE802.11, Bluetooth, or the like for connecting the access point 1 to each of the client personal computers 3, 4, 5, and 6 and the PDAs 7, 8, and 9.

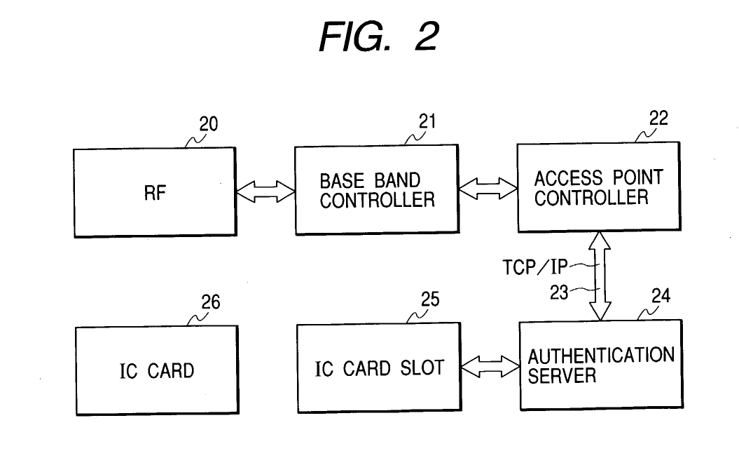

FIG. 2 is a block diagram showing an internal structure of the access point 1. The access point 1 comprises: a radio wave forming unit (RF) 20 of wireless communication; a wireless communication control circuit (hereinafter, referred to as a base band controller) 21; an access point controller 22 including a Media Access Control (MAC) circuit and the like; a TCP/IP 23 serving as communicating means for connecting the access point controller 22 and an authentication server 24; the authentication server 24 such as RADIUS or the like; an IC card slot 25 serving as an interface for supplying the account data to the authentication server 24; and a detachable IC card (detachable non-volatile memory device) 26 for holding the account data which is supplied to the authentication server 24 via the IC card slot 25.

In the above construction, when the client personal computers 3, 4, 5, and 6 and the PDAs 7, 8, and 9 intend to construct the network, if the user authentication such as IEEE802.1x or the like mentioned in the prior art is used, the safe wireless network can be established. However, as mentioned above, the authentication server connected to the access point 1 by the TCP/IP is indispensable for user authentication of IEEE802.1x or the like. To solve such a problem, in the embodiment, the authentication server 24 is fetched into the access point 1 as shown in FIG. 2. Further, the account data for the authentication server 24 is stored into the IC card (detachable non-volatile memory device) 26, the account data in the IC card (detachable non-volatile memory device) 26 is read out land stored into the authentication server 24 and used via the IC card slot 25 as necessary.

It is assumed that the client personal computer 3, which intends to establish the safe network by wireless communication with the access point 1 does not have the account to the authentication server. In this case, usually, the account is created via a procedure such as an account application or the like to a network administrator. In the embodiment, however, the owner of the client PC 3 extracts the IC card (detachable non-volatile memory device) 26 inserted into the IC card slot (2 in FIG. 1; 25 in FIG. 2) of the access point 1, inserts it into the IC card slot provided for the own client personal computer, and activates the program in the embodiment, so that the account can be created on the IC card (detachable non-volatile memory device) 26.

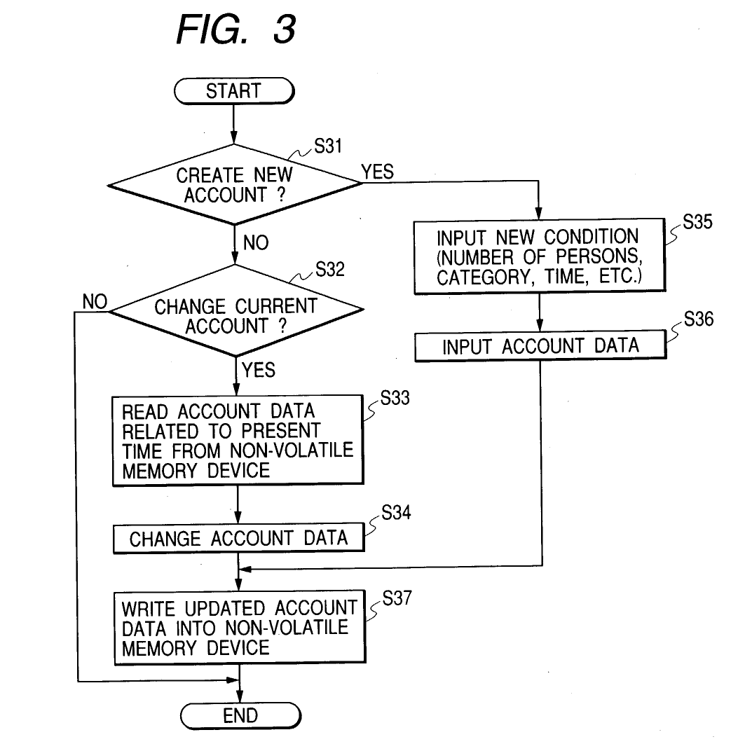

FIG. 3 is a flowchart showing the operation of an account database updating program (account creating program) which operates in the client device. As shown in FIG. 3, in the account database updating program, a flow of processes differs in dependence on the creation of new account data or the edit of the existing account data. In the case of editing the existing account data, on the basis of a calendar function or a timer function which functions in the client device and use time information stored in correspondence to the account data in the IC card, an account file to be used at the present time is automatically opened and its contents can be changed. By this method, in the case where the client PCs 4, 5, and 6 and the PDAs 7, 8, and 9 have already established the PAN having the account and the client PC 3 newly participates therein, the account of the client PC 3 can be easily created and the client PC 3 is enabled to participate in the PAN. The execution of the account database updating program is not limited to the client PC 3 but it can be executed by other client PCs 4, 5, and 6 and PDAs 7, 8, and 9.

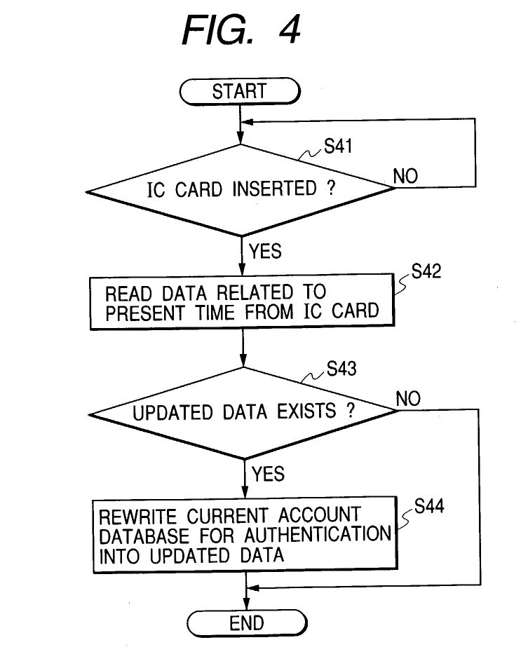

The flowchart of FIG. 3 will be explained in step order. First, in the client device, whether the operation is the creation of the new account data or the edit of the existing account data is discriminated (step S31). In the case of editing the existing account data, whether the edit is the edit to change the current account data or not is discriminated (step S32). If it is not the edit to change the current account data, the processing routine is finished. In the case of the edit to change the current account data, the account data related to the present time is read out from the detachable non-volatile memory device inserted into the IC card slot of the client device and stored into the memory in the client device (step S33), and the account data is changed (step S34). On the other hand, in the case of creating the new account data, new conditions such as the number of persons necessary for PAN establishment, each category (for example, distinction between the person whom a right of the access to the PAN is given and the person whom the access right is not given, or the like), PAN establishment time and the like are inputted (step S35), and the account data is inputted (step S36). After completion of the process in step S34 or S36, the updated account data is written into the nonvolatile memory device (step S37). The changed account data or the newly added account data is stored into the memory of the client device in order to execute the authenticating process of the access point 1. When processes in FIG. 4, which will be explained hereinlater, are finished and the client device starts to communicate with the access point 1 by the user operation, the access point is requested to make authentication of IEEE802.1x using the account data. In response to a challenge from the access point, the account name and the password are returned by using the account data and authentication of IEEE802.1x is made.

FIG. 4 is a flowchart showing the operation of the access point 1 in the case where the detachable non-volatile memory device 26 is inserted again into the access point 1, which will be explained in the embodiment, after the account data was updated. As shown in FIG. 4, if the updated data of the current account data exists in the inserted non-volatile memory device 26, the access point 1 immediately reads out the updated account data and substitutes it for the account data copied onto the memory of the own access point.

The flowchart of FIG. 4 will be explained in step order. First, whether the detachable nonvolatile memory device 26 has been inserted into the IC card slot 25 of the access point 1 or not is discriminated (step S41). If the detachable nonvolatile memory device 26 has been inserted, on the basis of the present time obtained by the calendar function or timer function which functions in the access point 1 and the use time information stored in correspondence to the account data in the IC card, the account data in the detachable non-volatile memory device 26 related to the present time is read out (step S42). Subsequently, the account data related to the present time, which has already been stored in the memory in the access point 1 is compared with the read-out account data and the presence or absence of the updated account data is discriminated (step S43). If the updated account data does not exist, the processing routine is finished. If the updated account data exists, the current account data, which is being used for authentication is replaced with the updated account data (step S44).

Subsequently, if an authenticating request from the client device is received, the authentication of IEEE802.1x is made by using the updated account data. After the elapse of the use time of the current account data, this account data is invalidated, thereby allowing the authentication in the account data after the elapse of the use time zone to be refused.

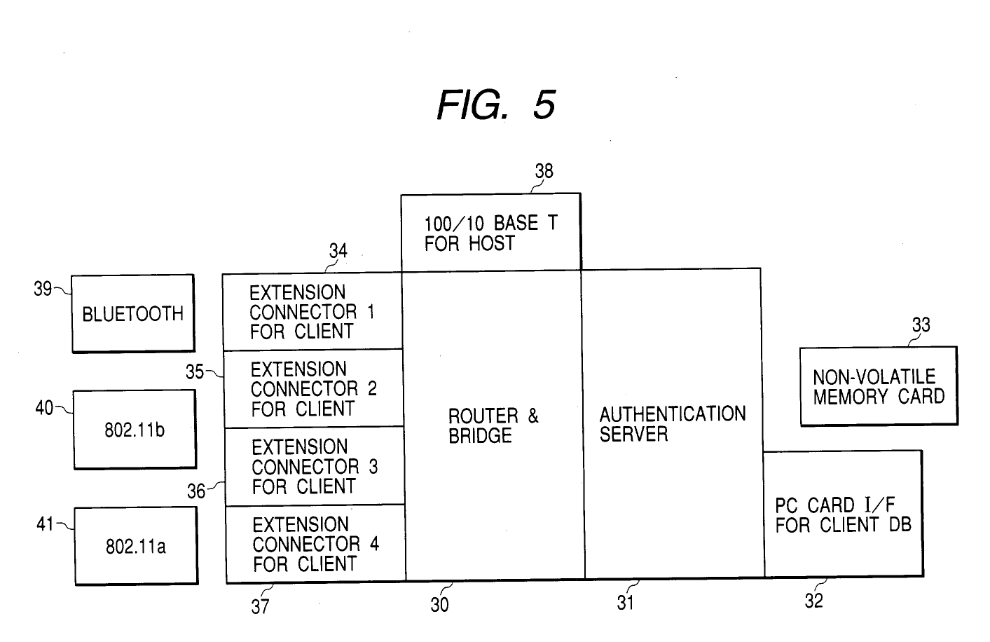

FIG. 5 is a block diagram showing an internal construction of the access point 1.

The access point 1 comprises: a router & bridge 30; an authentication server 31; a PC card interface 32 for a client database; a non-volatile memory card 33; a wireless communication board interface (extension connector 1 for the client) 34; a wireless communication board interface (extension connector 2 for the client) 35; a wireless communication board interface (extension connector 3 for the client) 36; a wireless communication board interface (extension connector 4 for the client) 37; a wired LAN interface (100/10 BaseT for host connection) 38; a Bluetooth extension board 39; an 802.11b extension board 40; and an 802.11a extension board 41.

The router & bridge 30 realizes a packet filter or routing (selection of a communication path) for traffic due to the TCP/IP among the client PCs 3 to 6 and the PDAs 7 to 9 connected to the access point 1 or traffic to the basic network such as Intranet, Internet, or the like. The authentication server 31 makes the authentication of IEEE802.1x or the like. The PC card I/F 32 is an interface of the nonvolatile memory card 33 for supplying the account data to the authentication server 31. The nonvolatile memory card 33 holds the account data, which is supplied to the authentication server 31. Each of the wireless communication board interfaces 34, 35, 36, and 37 is an interface for connecting a wireless communication board, which differs every wireless communicating means.

The wired LAN interface 38 is an interface for connecting the access point 1 to the basic network such as Intranet, Internet, or the like. The Bluetooth extension board 39 corresponds to the Bluetooth system as one of the wireless communicating means. By inserting the Bluetooth extension board 39 into one of the wireless communication board interfaces 34 to 37, the wireless communicating function by Bluetooth is provided for the access point 1. The 802.11b extension board 40 corresponds to the IEEE802.11b system as one of the wireless communicating means. By inserting the 802.11b extension board 40 into one of the wireless communication board interfaces 34 to 37, the wireless communicating function by IEEE802.11b is provided for the access point 1. The 802.11a extension board 41 corresponds to the IEEE802.11a system as one of the wireless communicating means. By inserting the 802.11a extension board 41 into one of the wireless communication board interfaces 34 to 37, the wireless communicating function by IEEE802.11a is provided for the access point 1.

As shown in FIG. 5, the access point 1 according to the embodiment realizes the wireless communication by inserting the wireless communication extension boards 39 to 41 into the wireless communication board interfaces 34 to 37. Therefore, it is necessary that the wireless communication board interfaces 34 to 37 have a flexible construction in order to cope with a plurality of wireless systems.

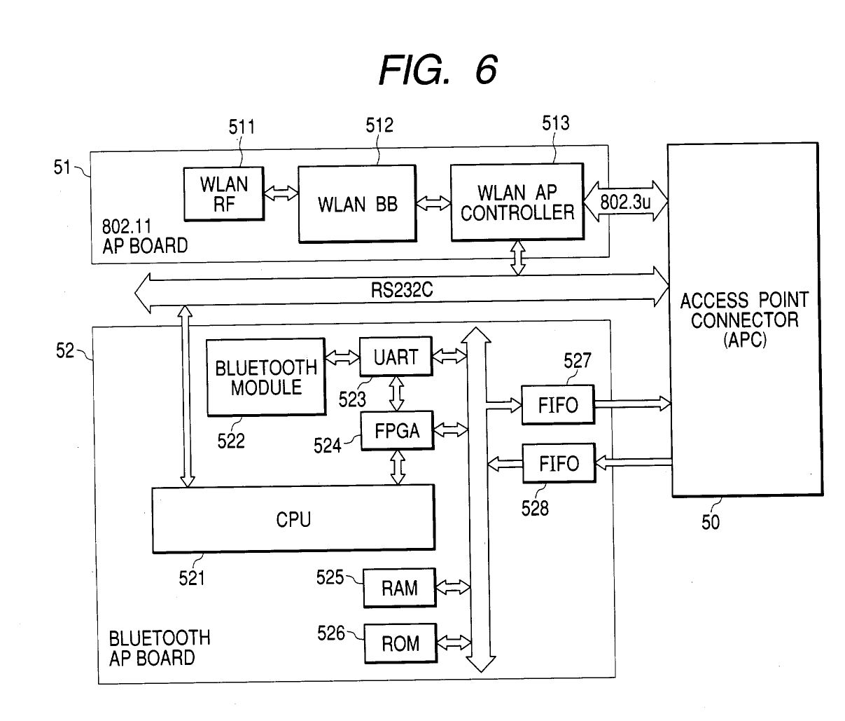

FIG. 6 is a block diagram showing the construction of the wireless communication board interfaces. Each of the wireless communication board interfaces comprises: a wireless communication board interface connector (access point connector: APC) 50; a wireless LAN extension board 51 which has a wireless LAN RF 511, a wireless LAN BB (Base Band) 512, and a wireless LAN access point controller 513 and corresponds to the IEEE802.11 system as a standard of the wireless LAN; and a Bluetooth extension board 52 which has a CPU 521, a Bluetooth module 522, a UART (Universal Asynchronous Receiver Transmitter) 523, an FPGA (Field Programmable Gate Array) 524, a RAM 525, a ROM 526, a FIFO (First In First Out) memory 527, and a FIFO memory 528 and corresponds to Bluetooth.

According to FIG. 6, the interface by which the wireless LAN extension board 51 is connected to the router & bridge 30 is 802.3u and a serial port (RS232C) as a wire LAN interface standard. The interface by which the Bluetooth extension board 52 is connected to the router & bridge 30 is a bus connection and the serial port (RS232C) via the FIFO memories 527 and 528. As mentioned above, since there is a case where the specifications which are required for the wireless communication board interface connector 50 differ in dependence on the wireless communicating means to be connected, the access point 1 in the embodiment corresponds to signals indicative of both of the interface specifications so that it can cope with both of the wireless LAN extension board 51 and the Bluetooth extension board 52.

Further, a plurality of wireless communication board interface connectors 50 are provided for the access point 1 in the embodiment, thereby realizing a construction such that different wireless communication extension boards are mixedly installed or a plurality of same wireless communication boards are installed. Owing to the construction in which the different wireless communication extension boards are mixedly installed, even in the case where the wireless communicating means 10, 11, 12, and 13, which are used by the client personal computers 3, 4, 5, and 6 in FIG. 1 are based on the IEEE802.11b system and the wireless communicating means 14, 15, and 16, which are used by the PDAs 7, 8, and 9 are based on the Bluetooth system, the safe wireless communication network can be established by one access point.

Owing to the construction in which a plurality of same wireless communication boards is installed, the number of clients, which can be supported by one wireless communication extension board can be increased. For example, by inserting the wireless communication extension board 39 of the Bluetooth system into the four wireless communication board interfaces 34, 35, 36, and 37, since the upper limit of the number of clients upon creation of a Pico net of the Bluetooth system is equal to 7, the wireless communication network by total of 28 persons in which seven persons are provided for each board can be formed. Also in the case of the wireless LAN system, the logical upper limit of the corresponding number of clients of the wireless communication extension boards 40 and 41 is equal to 255 and this value is at a level of no problem. However, actually, there is a limitation of about 10 to 15 clients per wireless communication extension board because of a problem of the processing ability of the wireless communication extension boards 40 and 41. Also in this case, the limitation of the number of clients can be lightened by inserting a plurality of wireless communication extension boards 40 and 41 corresponding to the wireless LAN into the wireless communication board interfaces 34, 35, 36, and 37.

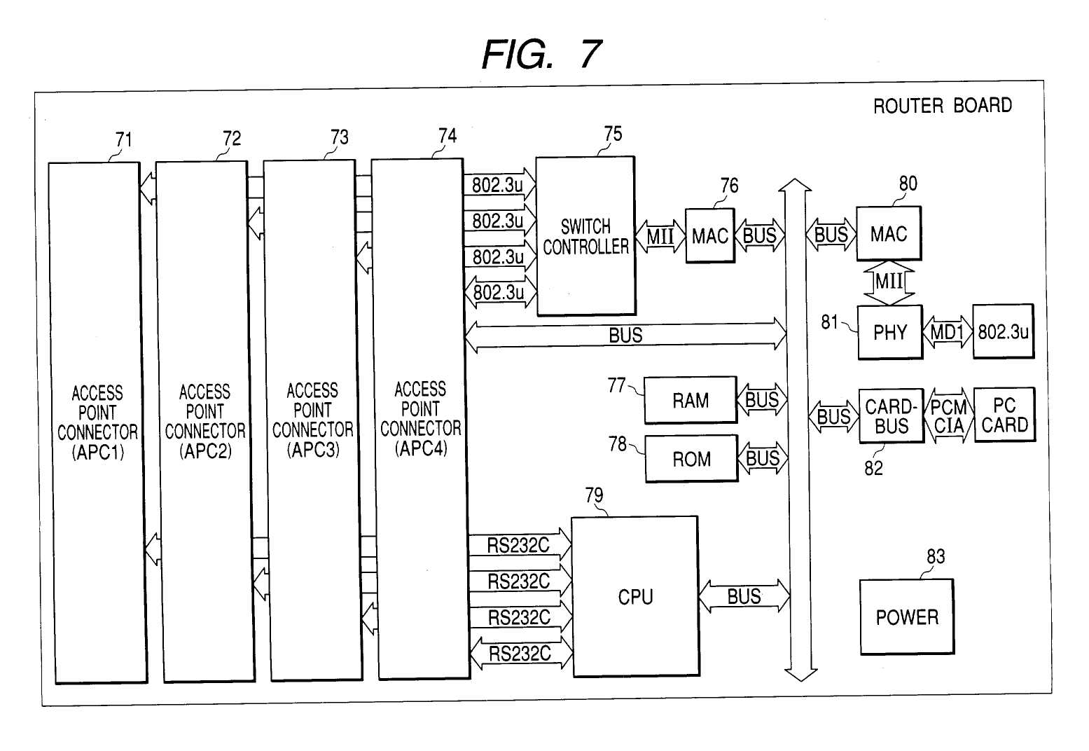

FIG. 7 is a block diagram showing a detailed construction of the portion of the router & bridge 30, authentication server 31, PC card interface 32 for the non-volatile memory, wireless communication board interfaces 34, 35, 36, and 37, and wire LAN interface 38 of the access point 1 in the embodiment. The access point 1 comprises: an interface (APC1) 71 for the wireless communication extension board; an interface (APC2) 72 for the wireless communication extension board; an interface (APC3) 73 for the wireless communication extension board; an interface (APC4) 74 for the wireless communication extension board; a switch controller 75; a MAC (Media Access Control) 76; a RAM 77; a ROM 78; a CPU 79; a MAC 80; a PHY (Physical Layer Protocol) 81; a card-bus 82; and a power source 83. A whole construction of FIG. 7 is called a main board.

As shown in FIG. 7, the access point 1 in the embodiment has a plurality of interfaces (APC1-71, APC2-72, APC3-73, APC4-74) for the wireless communication extension boards. Each of them has an 802.3u interface, a bus interface, and a serial interface (RS232C). Thus, the wireless communication extension boards, 39, 40, and 41 mentioned above can be inserted into any of those connectors.

As one of the features of the embodiment, a feature such that the authentication server 31 shown in FIG. 5 is built in the access point 1 can be mentioned. As a simplest method of realizing such a function, there is a method whereby the authentication server 31 is constructed for the authentication server 24 shown in FIG. 2 by providing a circuit comprising a dedicated CPU and a memory and the authentication server 31 and the router & bridge 30 are coupled by the interface of 802.3u corresponding to the TCP/IP. However, if such a method is used, since the system overlappingly has the circuits each comprising the CPU and the memory, there is large uselessness. Therefore, in the embodiment, by emulating the authentication server function by the router & bridge 30, uselessness of hardware resources is omitted. That is, a network application such as routing or the like and an authentication server emulation (RADIUS server emulation) are concurrently (in parallel) executed by the CPU 79 portion in FIG. 7, thereby realizing efficient hardware.

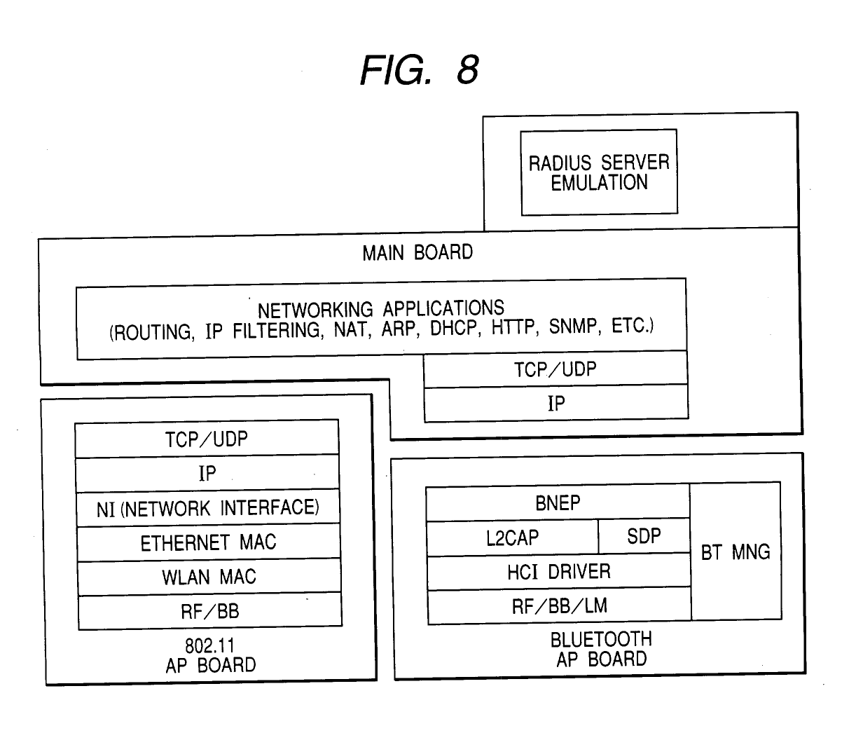

FIG. 8 is a diagram showing a stuck structure of software processes which are executed by: the main board portion comprising the router & bridge 30, authentication server 31, PC card interface 32, wireless communication board interfaces 34, 35, 36, and 37, and wire LAN interface 38 of the access point 1 in the embodiment; and each of the Bluetooth extension wireless communication board 39 and the wireless LAN extension wireless communication boards 40 and 41.

As shown in FIG. 8, the RADIUS server emulation as an authentication server emulation is executed on the main board. Since the authentication server emulation is executed on the main board, high performance is required for the CPU on the main board. To effectively use such performance, as shown in FIG. 8, correspondence to the TCP/IP by a LAN profile of a heavy load is not performed on the Bluetooth extension wireless communication board 39 but a software layer of the TCP/IP is added to BNEP on the main board. By making such correspondence, on the Bluetooth extension wireless communication board 39, since it is sufficient to execute a PAN profile of a relatively light process, communicating performance that the Bluetooth extension wireless communication board has can be effectively used.

An object of the construction in which both of the wireless communicating means of the wireless LAN (802.11) and Bluetooth are integrated at the TCP/IP level is to enable a network application locating at an upper position to be used in common irrespective of the actual wireless communicating means by arranging both of them to the layer of the TCP/IP and to unite the access means to the authentication server to the TCP/IP.

As described above, according to the first embodiment, the safe wireless network can be easily and flexibly established by a simple system construction by using the wireless communication authenticating means according to the IEEE802.1x system. Needs for PAN establishment as mentioned above are optimum in the case where it is intended to temporarily establish the safe network for a conference or the like, etc.

Second Embodiment

As mentioned in the first embodiment, the access point 1 is characterized in that the portion which comprises the router & bridge 30, authentication server 31, PC card interface 32 for supplying the account data to the authentication server 31 and can be connected also to the wireless communicating portion and the basic network which can flexibly cope with various wireless communication systems is equipped in a compact casing and the safe wireless network with the client devices 3, 4, 5, 6, 7, 8, and 9 can be flexibly realized by a simple construction.

In the first embodiment, explanation has been made with respect to the means for supplying the client data for making authentication on the basis of IEEE802.1x to the authentication server, the means for updating the data, and the means for assuring flexibility in selection of the wireless communicating means on the access point side. On the other hand, in the second embodiment, an example on the side of the client devices (client personal computers, PDAs) of the access point 1 in the above first embodiment will be explained.

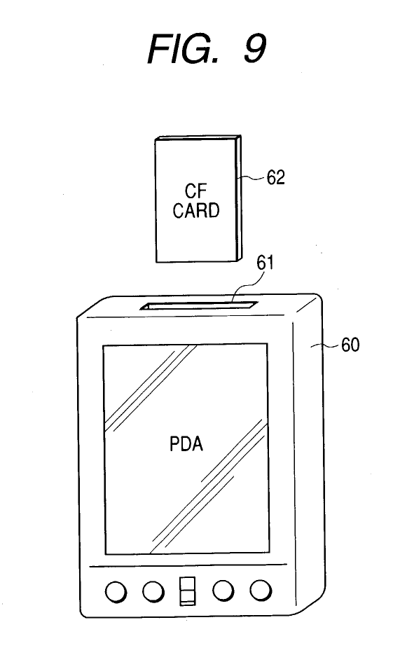

FIG. 9 is an external view showing a structure of a PDA as a client device according to the second embodiment and a diagram preferably illustrating a feature of the embodiment. A client device (PDA) 60 corresponds to wireless communication. A CF card slot 61 is equipped in a casing of the PDA 60. A CF card 62 is a detachable non-volatile memory device for supplying client data to the PDA 60 by being inserted into the CF card slot 61.

In the first embodiment, explanation has been made with respect to the construction in which the account data on the detachable non-volatile memory device for supplying the account data for the authentication server to the access point 1 can be easily updated by an account database updating program that operates in the client device. The account data formed by the account database updating program can be used not only by the access point 1 but also by the client device (PDA) 60. In this case, although it is sufficient to collectively manage the data of all clients on the side of the access point 1, since the client device (PDA) 60 has to make connection by using different accounts, it is necessary to discriminate which account can be used.

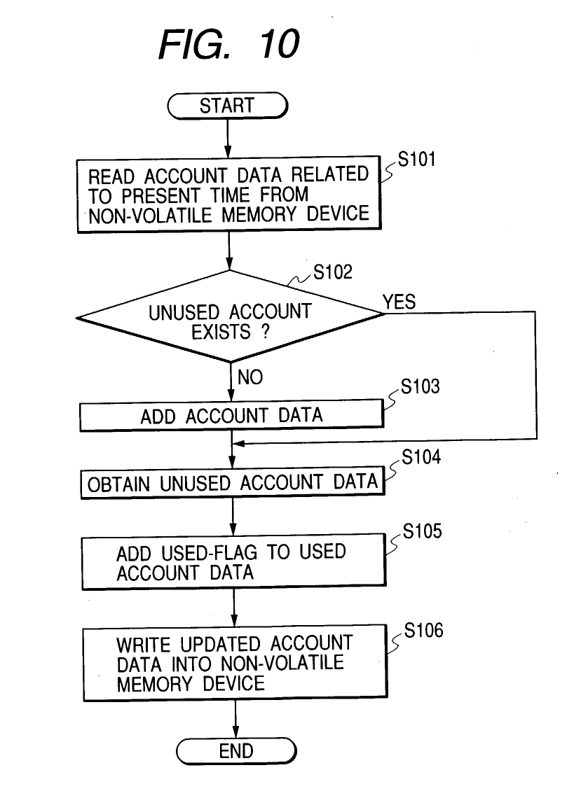

FIG. 10 is a flowchart showing processes, which are executed when the account data is obtained from the CF card (detachable non-volatile memory device) 62 by the client device (PDA) 60. As shown in FIG. 10, when the client device 60 obtains the account data from the CF card (detachable non-volatile memory device) 62, the current account data is read out and stored into a memory on the client device 60 (step S101) on the basis of the time information obtained by the calendar function or the timer function of the client device and the use time information stored in correspondence to the account data in the CF card. After that, whether the unused account data is included in the read-out account data or not is discriminated (step S102). If no unused account data exists, account data is newly added (step S103) and step S104 follows. If the unused account data exists, the account data is not added but step S104 follows.

If YES in step S102 or after completion of the process in step S103, the unused account data is obtained (step S104). This account data is stored into the memory on the client device (PDA) 60. Further, a used flag is added to the used account data (step S105). Thereafter, the updated account data is written into the CF card (detachable nonvolatile memory device) 62 (step S106). The system prepares for the next reading of the account data of the client device (PDA) 60.

When the addition of the account data is executed, the CF card (detachable non-volatile memory device) 62 which executed the updating of the account data is inserted into the access point 1 and the updating process of the account data shown in FIG. 4 is executed, thereby reflecting the updated account data to the access point 1. If the addition of the account data is not executed, since there is no need to change the account data stored in the access point 1, it is unnecessary to execute the operation to insert the CF card (detachable non-volatile memory device) 62 into the access point 1.

When the wireless LAN is limited to a certain access point and a certain client and the network is established, an ESS ID (Extended Service Set Identity: which is used in setting of roaming for automatically switching the connection when a wireless terminal moves in an area that is covered by the access point, or the like) is generally changed every network. In the embodiment, however, the ESS ID information is stored into the detachable nonvolatile memory device together with the account data and the wireless LAN network is established on the basis of the ESS ID information read out upon establishment of the PAN, so that a desired access point and a desired client device or an extension wireless communication card in the desired access point and the desired client device can be connected to the network. The real-timer clock information built in the access point is compared with the information showing the PAN establishment time, which is supplied from the detachable non-volatile memory device. The wireless communication parameters of the access point are automatically set on the basis of the account data in which both of those information coincide.

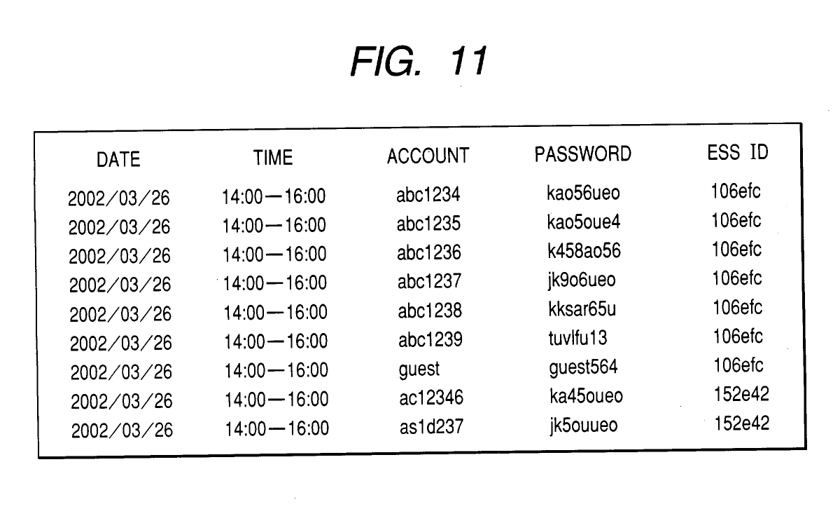

FIG. 11 is a diagram showing an example of the ESS ID information related to the account data. In this example, seven clients related to ESS ID “106efc” are connected to the access point having the same ESS ID of “106efc.” Two clients related to ESS ID “152e42” are connected to the access point having the ESS ID of the same “152e42.” Similarly, in the access point such that different wireless communicating means or a plurality of extension wireless communication cards corresponding to the same wireless communicating means are provided in one access point, the extension wireless communication cards in the access point and the client devices can be connected to the network by using the ESS ID information related to the account data mentioned above. That is, if an extension board A for wireless LAN using the ESS ID of “106efc” and a wireless LAN extension board B using the ESS ID of “152e42” are connected to the access point 1, the client device using the ESS ID of “106efc” is connected to the extension board A and the client device using the ESS ID of “152e42” is connected to the extension board B. Thus, the extension boards are selectively used in accordance with the account data of the client device.

As described above, according to the second embodiment, the safe wireless network can be easily and flexibly established by a simple system construction in a manner similar to the first embodiment.

Third Embodiment

As mentioned in the first and second embodiments, the authentication server and client devices in the access point 1 are characterized in that the information such as account data for the PAN established by them, ESS ID, and the like is obtained by the detachable non-volatile memory device. However, the obtaining method of those information is not limited to the method of obtaining it from the detachable non-volatile memory device but it can be previously fetched into the non-volatile memory built in the access point or the client device via the network and used.

For this purpose, the following procedure is necessary. That is, the user who intends to establish the PAN activates the account database forming program, creates the account data, attaches the created data to E-mail, and sends the resultant E-mail, and the user of each client device executes the operation to store the attached data, or the account data is held in a shared folder by using a file sharing program such as P2P (Peer To Peer) or the like and the user of each client device previously downloads and stores it.

By using those means, the account data and the ESS ID can be obtained without using the detachable non-volatile memory device. However, since the access point itself does not have an E-mail address and is not always connected to the network, it is desirable that both of the storage via the network and the supply by the detachable non-volatile memory device are used together for management of the account data.

As described above, according to the third embodiment, the safe wireless network can be easily and flexibly established by a simple system construction in a manner similar to the first embodiment.

Another Embodiment

Although the network system with the construction as shown in FIG. 1 has been mentioned as an example in the above embodiments, the invention is not limited to it but the number of client devices, which are installed, the types of client devices, and the like can be arbitrarily set.

The invention can be applied to a system constructed by a plurality of apparatuses or an apparatus constructed by one equipment. Naturally, the invention is also accomplished by a method whereby a medium such as a memory medium in which program codes of the software for realizing the functions of the embodiments mentioned above have been stored is supplied to a system or an apparatus and a computer (or a CPU or an MPU) of the system or apparatus reads out the program codes stored in the medium such as a memory medium and executes them.

In this case, the program codes themselves read out from the medium such as a memory medium realize the functions of the embodiments mentioned above and the medium such as a memory medium in which the program codes have been stored constructs the invention. As a medium such as a memory medium for supplying the program codes, for example, a floppy (registered trademark) disk, a hard disk, an optical disk, a magnetooptic disk, a CD-ROM, a CD-R, a magnetic tape, a non-volatile memory card, a ROM, downloading via the network, or the like can be used.

Naturally, the invention incorporates not only a case where a computer executes the read-out program codes, so that the functions of the embodiments mentioned above are realized but also a case where an OS (Operating System) or the like which is operating on the computer executes a part or all of actual processes on the basis of instructions of the program codes and the functions of the embodiments mentioned above are realized by those processes.

Further, naturally, the invention also incorporates a case where the program codes read out from the medium such as a memory medium are written into a memory provided for a function expanding board inserted in a computer or a function expanding unit connected to a computer and, thereafter, a CPU or the like provided for the function expanding board or the function expanding unit executes a part or all of actual processes on the basis of instructions of the program codes, and the functions of the embodiments mentioned above are realized by those processes.

As described above, according to the invention, the safe wireless network can be easily and flexibly established by a simple system construction. Such needs for PAN establishment are optimum in the case where the user wants to temporarily establish the safe network for a conference or the like, etc.

What is claimed is:

1. An access point for making access control of a communicating apparatus, comprising:
memory means for reading out account data stored in a detachable memory device and storing it;
an authentication server function for authenticating said communicating apparatus on the basis of the account data stored in said memory means;
discriminating means for discriminating that the account data stored in said detachable memory device has been updated; and
control means for controlling so as to rewrite the account data stored in said memory means on the basis of a result of the discrimination of said discriminating means.

2. An access point according to claim 1, further comprising a wireless communication extension interface corresponding to a plurality of wireless communicating functions, and
wherein by selectively attaching a wireless communication card to said wireless communication extension interface, wireless communication with said communicating apparatus by a different wireless communicating function can be made.

3. An access point according to claim 2, wherein a plurality of said wireless communication extension interfaces are provided.

4. An access point according to claim 1, further comprising a wire interface for connecting to a wire network, and
wherein said communicating apparatus is a wireless communicating apparatus, and
said access point enables a communication path between said wireless communicating apparatus and said wire network to be selected.

5. An access point according to claim 4, wherein an emulation process of said authentication server function is executed by a control unit for executing the communication path selecting process.

6. An access point according to claim 1, wherein said authentication server function executes said authenticating process by using account data related to present time in the account data stored in said detachable memory device.

7. An access point according to claim 1, wherein said discriminating means discriminates that the account data related to time when said detachable memory device has been connected has been updated.

8. An access point according to claim 1, further comprising a wire interface for connecting to a wire network, and
wherein said memory means also stores account data for said authentication server function received via said wire network.

9. An access point according to claim 1, wherein all account data, which is managed by said access point is stored in said detachable memory device.

10. An access point according to claim 1, wherein said authentication server function makes authentication, which is specified by IEEE802.1x.

11. An access point according to claim 1, further comprising a plurality of wireless communication interfaces, and
wherein said communicating apparatus is a wireless communicating apparatus, and
the wireless communication interface which is used by said wireless communicating apparatus is selected in accordance with said account data.

12. A communicating apparatus comprising:
an interface for attaching a detachable memory device in which account data that is used when an access point having an authentication server function authenticates the communicating apparatus has been stored;
editing means for editing the account data stored in said detachable memory device attached to said interface; and
authenticating means for executing the authenticating process of said access point by using the account data edited by said editing means.

13. A system having an access point for making access control of a communicating apparatus and said communicating apparatus, wherein
said access point comprises:
an authentication server function for authenticating said communicating apparatus on the basis of account data stored in a memory;
discriminating means for discriminating that the account data stored in a detachable memory device has been updated; and
control means for controlling so as to rewrite the account data stored in said memory on the basis of a result of the discrimination of said discriminating means, and
said communicating apparatus comprises:
editing means for editing the account data stored in said attached detachable memory device; and
authenticating means for executing the authenticating process of said access point by using the account data edited by said editing means.

14. A control method for an access point having an authentication server function for authenticating a communicating apparatus on the basis of account data stored in a memory, comprising:
a memory step of reading out account data stored in a detachable memory device and storing it into said memory;
a discriminating step of discriminating that after the account data was stored into said memory in said memory step, the account data stored in said detachable memory device has been updated in an attached detachable memory device; and
a control step of controlling so as to rewrite the account data stored in said memory on the basis of a result of the discrimination of said discriminating step.

15. A control method for a communicating apparatus having an interface to attach a detachable memory device in which account data that is used when an access point having an authentication server function authenticates the communicating apparatus has been stored, comprising:
an editing step of editing the account data stored in said detachable memory device attached to said interface; and
an authenticating step of executing an authenticating process of said access point by using the account data edited in said editing step.
